(19) United States
(12) Patent Application Publication
(10) Pub. No.: US 2004/0037979 A1
(43) Pub. Date: Feb. 26, 2004

(54) Pressurized elastomer mount

(76) Inventor: Robert James Monson, St. Paul, MN (US)

Correspondence Address: Carl L. Johnson, Jacobson and Johnson, Suite 285, One West Water Street, St. Paul, MN, 55107-2080, US

(21) Appl. No.: 10/225,316

(22) Filed: Aug. 21, 2002

(51) Int. Cl. B32B 1/02; B32B 1/08; F16F 9/12; F16D 57/00; B23P 11/00; B23P 17/00; B21D 51/16

(52) U.S. Cl. 428/34.1; 428/36.8; 188/266; 29/434; 29/890.09

(57) ABSTRACT

A hollow elastomer shell with an apex end and a base end with the apex end and the base end having support surfaces thereon to provide compressive support and a pressure equalizer to maintain substantial pressure equalization between the interior of the elastomer shell and the exterior of the elastomer shell to prevent a fluid pressure differential between the interior of the hollow elastomer shell and the exterior of the hollow elastomer shell from prematurely limiting an elastomeric response of the shock isolator.

### FIELD OF THE INVENTION

This invention relates to shock isolators and, more specifically, to shock isolators that can provide compressive support while at the same time providing an extended range of operation through equalization of pressure inside and outside of the shock isolator.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF T HE INVENTION

Various elastomeric materials have been used, or suggested for use, to provide shock and/or vibration damping as stated in U.S. Pat. No. 5,766,720, which issued on Jun. 16, 1998 to Yamagisht, et al. These materials include natural rubbers and synthetic resins such as polyvinyl chlorides, polyurethane, polyamides polystyrenes, copolymerized polyvinyl chlorides, and poloyolefine synthetic rubbers as well as synthetic materials such as urethane, EPDM, styrene-butadiene rubbers, nitrites, isoprene, chloroprenes, propylene, and silicones. The particular type of elastomeric material is not critical but urethane material sold under the trademark Sorbothane® is currently employed. Suitable material is also sold by Aero E.A.R. Specialty Composites, as Isoloss VL. The registrant of the mark Sorbothane® for urethane material is the Hamiltion Kent Manufacturing Company (Registration No. 1,208,333), Kent, Ohio 44240.

Generally, the shape and configuration of elastomeric isolators have a significant effect on the shock and vibration attenuation characteristics of the elastomeric isolators. The elastomeric isolators employed in the prior art are commonly formed into geometric 3D shapes, such as spheres, squares, right circular cylinders, cones, rectangles and the like as illustrated in U.S. Pat. No. 5,776,720. These elastomeric isolators are typically attached to a housing to protect equipment within the housing from the effects of shock and vibration. The prior art elastomeric isolators are generally positioned to rely on an axial compression of the elastomeric material or on tension or shear of the elastomeric material. Generally, if the elastomeric isolator is positioned in the axial compressive mode the ability of the elastomeric isolator to attenuate shock and vibration is limited by the compressive characteristics of the material. On the other hand, in the axial compressive mode the elastomeric isolators can be used to provide static support to a housing, which allows a single elastomeric isolator to be placed beneath the housing to support the static weight of the housing.

In general, if the elastomeric isolators are positioned in the shear or tension mode as opposed to an axial compression mode the elastomeric isolators provide better shock and vibration attenuating characteristics in response to dynamic forces due to shock and vibration. Unfortunately, elastomeric isolators, which operate in a shear or tension mode or in the axial compression mode, can generally not be placed beneath a housing to provide static support to the housing without substantially effecting the shock and vibration attenuation characteristics of the elastomeric isolators. Consequently, to provide static support for a housing, as well as effective shock and vibration attenuation characteristics the elastomeric isolators, which operate in the shear or tension mode, are generally placed along side or above a housing so that the elastomeric isolators can function in a shear or tension mode while tensionally supporting the static weight of the housing. The positioning in a shear or tension mode can require placing matching elastomeric isolators on each side of the housing. In one embodiment an elastomeric isolator provides compressive static support for a housing through shear resistance and in other embodiments the elastomer isolators provide compression resistance.

One of the difficulties with shock isolators and particularly with elastomer shell isolators that function in the shear mode is that a fluid, which is maintained within a cavity of the shock isolator, can shorten the effective operating range of the isolator. That is, a shock isolator, which provides shear resistance to shock and vibration forces, begins to provide a non-shear response as the force on the shock isolator increases. This reduced effectiveness of the shock isolator is due to an increase of fluid pressure within the shock isolator. While increasing the pressure of fluid within a shock isolator has been used to increase the ability of a shock to support a compressive load, the present invention provides a contrary effect by incorporating a pressure equalizer in the shock isolator that allows the pressure of fluid inside and outside of the shock isolator to remain in equilibrium or in a near equilibrium condition thereby allowing the resistance to shock and vibration to be provided solely by the characteristics of the elastomer and the elastomer configuration.

### SUMMARY OF THE INVENTION

An elastomer shock isolator to support the static weight of a housing while at the same time effectively attenuating shock or vibration imparted to the housing with the shock isolator having a pressure equalizer for equalizing the fluid pressure inside and outside of the shock isolator to prevent the fluid pressure within the shock isolator from limiting the elastomeric operating range of the shock isolator.

### BRIEF DESCRIPTION OF THE DRAWINGS

FIG. 1 is perspective view of a two-tetrahedron elastomer shock isolator;

FIG. 2 is a partial sectional side view of the two-tetrahedron elastomer shock isolator of FIG. 1 with base end members secured to the ends of the shock isolator;

FIG. 3 is a sectional view taken along lines 3-3 of FIG. 2;

FIG. 4 is a front elevation view showing the two-tetrahedron elastomer shock isolator of FIG. 1 supporting the weight of a cabinet or housing;

FIG. 4A is a cross sectional view of a two-tetrahedron elastomer shock isolator with a pressure equalizer located in a base member of the elastomer shock isolator;

FIG. 5 is a cross sectional view of a two-tetrahedron elastomer shock isolator with pressure equalizer connected to the shock isolator; and

FIG. 7 is a plot of the force versus displacement for a shock isolator having a pressure equalizer and a shock isolator without a pressure equalizer.

### DESCRIPTION OF THE PREFERRED EMBODIMENT

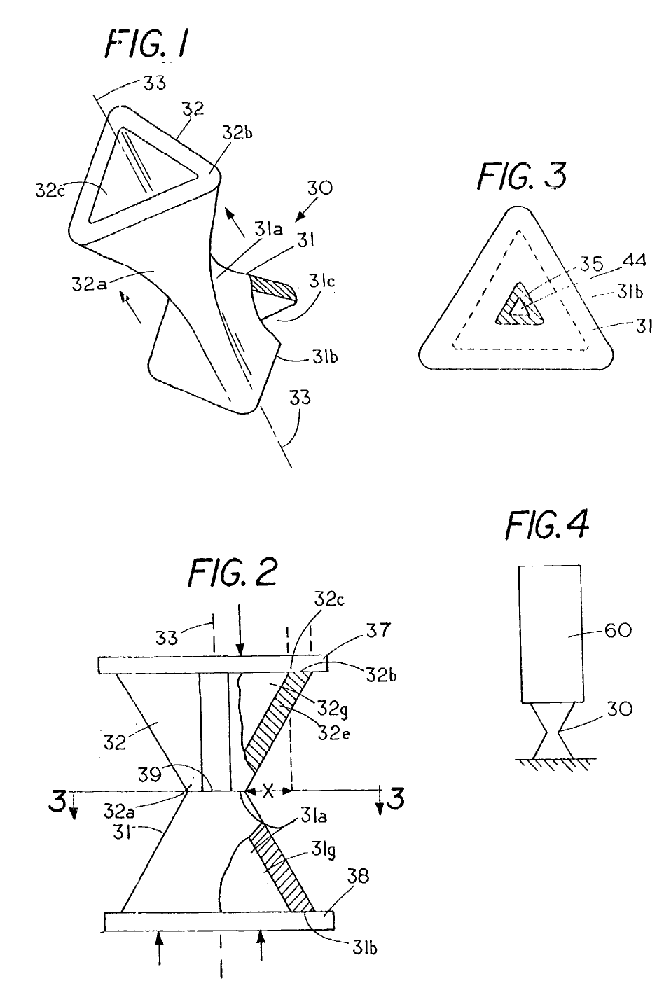

FIG. 1 is a perspective view of a one-piece shock isolator 30 for providing shock and vibration attenuation while providing axially offset support to an object. Isolator 30 is a one-piece two-tetrahedron elastomer shock isolator 30 that simultaneously isolates shocks and supports a static load. Shock isolator 30 has a set of integral elastomer side walls forming a first tetrahedron elastomer shell 31 with a tetrahedron shaped cavity 31c therein and a second tetrahedron elastomer shell 32 having a set of integral elastomer side walls forming a second tetrahedron elastomer shell with a tetrahedron shaped cavity 32c therein. A central axis 33 is shown extending through an apex end 32a of elastomer shell 32 and an apex end 31a of elastomer shell 31. FIG. 2 shows apex end 31a and apex end 32a are smoothly joined to each other at junction surface 39 to form the one-piece two-tetrahedron elastomer shock isolator.

FIG. 1 shows the top tetrahedron elastomer shell 32 has a triangular shaped base end that forms a first support surface 32b. Similarly, the bottom tetrahedron elastomer shell 31 has a triangular shaped base end that forms a second support surface 31b. The conjunction of the apex ends of the two-tetrahedron elastomer shells provides an integral force transfer region between the triangular shaped base ends 31b and 32b of the two-tetrahedron elastomer shells 31 and 32.

In order to provide shear resistance the base ends 31b and 32b are laterally offset with respect to the conjoined area 35 (FIG. 3), which occurs at the conjunction of the apex ends of tetrahedron elastomer shells 31 and 32. That is, a line parallel to axis 33 that extends through base end or first support surface 32b does not extend through the conjoined area 35 between the apex of the two-tetrahedron elastomers 31 and 32. Similarly, a line parallel to axis 33 that extends through the second base end or support surface 31b does not extend through the conjoined area between the two apex ends 31a and 32a of the two-tetrahedron elastomers 31 and 32. Consequently, forces applied to base ends produce shear within the elastomer. This type of elastomer shock isolator which functions in the shear mode is more fully shown and described in my copending application titled Double Triad Elastomer Mount Ser. No. 09/779,423 Filed Feb. 8, 2001 and is hereby incorporated herein by reference.

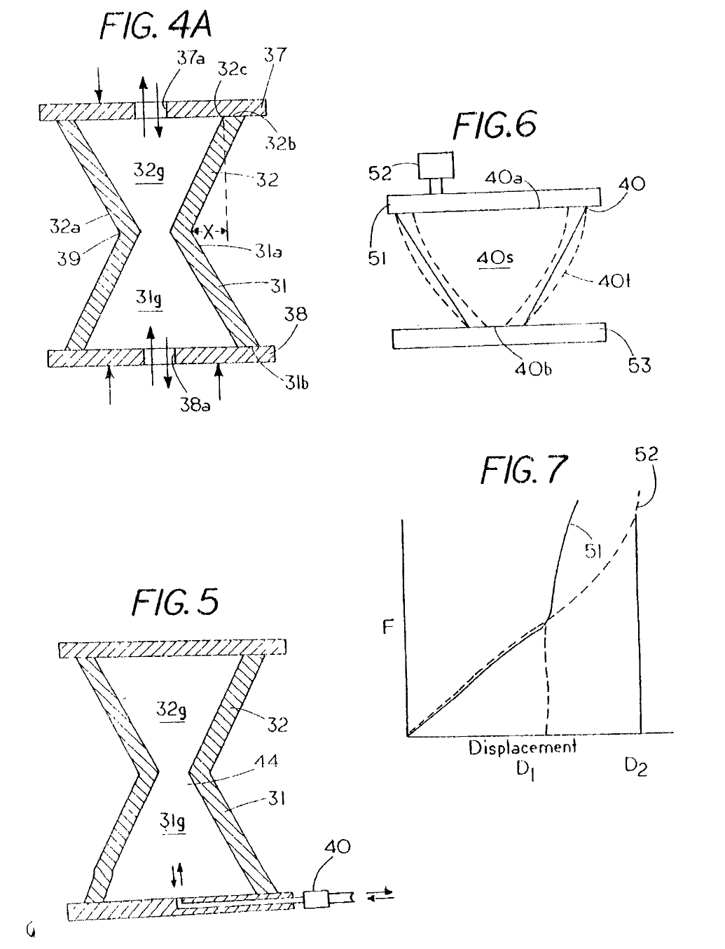

FIG. 2 shows a partial side elevation view of two-tetrahedron shock isolator 30 with a section line 3-3 extending though the conjoined region 39 between the two-tetrahedron elastomer shells 31 and 32. FIG. 2 illustrates the rotational location of the top tetrahedron elastomer 32 with respect to the bottom tetrahedron elastomer 31. A rigid base member 37 is secured to base end 32b and likewise a rigid base member 38 is secured to base end 31b. FIG. 4 shows the two-tetrahedron elastomer shock isolator 30 supporting the static weight of a housing 60, which contains equipment to be protected from shock and vibration. Note, a single shock isolator 30 can provide unpaired support for the housing while at the same time provide the proper shock and vibration attenuation characteristics. Although a single shock isolator 30 is shown supporting an article, multiple shock isolators can be used to coactively support an article to be protected from shock and vibration.

FIG. 3 shows a cross sectional view of the two tetrahedron shock isolator 30 showing the apex conjoined area 35 where forces are transferred between the apex ends of the two-tetrahedron elastomer shells 31 and 32. For illustrative purposes the outline of the bottom support surface 31b is shown in dotted lines. As evident from FIG. 3 the conjoined region or area 35 is laterally offset from the outer triangular shaped area 31b that forms the bottom support for shock isolator 31. In the embodiment shown a fluid passage 44 extends between the top tetrahedron elastomer shell 32 and the bottom tetrahedron elastomer shell 31 to allow flow of fluid between the cavities in each of the elastomer shells. The flow of fluid between cavities can be controlled by positioning an appropriate size orifice between the adjacent chambers or cavities.

FIG. 4A shows a cross sectional view of the two-tetrahedron elastomer shock isolator 30 with a first rigid plate or base member 37 secured to the triangular shaped base end 32b of tetrahedron elastomer shell 32 and a second rigid plate 38 secured to the triangular shaped base end 31b of tetrahedron elastomer shell 31.

An elastomer wall 32e forms an elastomer shell that extends angularly upward form apex end 32a to engage base member at position 32c. The triangular shaped base member 32 engages the base 37 and defines an inner boundary or inner periphery 32c of the support surface 32b of tetrahedron shock isolator 32. The lateral distance of the conjoined region 39 from the inner periphery 32c of tetrahedron shock isolator 32 is denoted by “x” with the distance x equal to or greater than 0 to thereby provide a cantilever support. That is the lateral offset of the base end 32b from the apex end 32a prevents the elastomer sidewalls from acting in an axial compression mode. Instead the elastomer sidewalls provide compression support through an axial offset axis that allows the elastomer walls of each of the two-tetrahedron shock isolators to move circumferentially inwards and outwards in response to dynamic forces.

Located in rigid base end 37 is a pressure equalizer comprises an opening 37a with the opening sufficiently large to vent fluid within the cavity 32g without the pressure of the fluid in the cavity substantially interfering with an elastomeric response of the shock isolator. Similarly, located in rigid base end 38 is a second pressure equalizer comprises an opening 38a sufficiently large to vent fluid within the cavity 31g without the pressure of the fluid in the cavity substantially interfering with an elastomeric response of the shock isolator. That is, when isolator 30 is compressed the volume of cavities 31g and 32g decreases, which normally would cause the pressure within the isolator to increase. Even if the fluid is compressible, such as air, the pressure increase results in an alteration of the dynamic response of the shock isolator. Through use of a pressure equalizer one can maintain the dynamic response of the shock isolator as a function of the elastomeric shear resistance to shock and vibration forces.

Referring to FIG. 5 there is shown an identical shock isolator having elastomer sidewalls 32 and 31 forming elastomer shells. Instead of the pressure equalizer comprising a vent passage, the pressure equalizer comprises a valve 40 valve normally remains in a closed condition until a pressure in the cavities 31g and 32g, which are connected by a fluid passage 44, exceed a venting pressure whereupon the valve 40 opens to vent fluid from within the cavities 31g and 32g. The venting of the fluid within the cavities prevents the fluid pressure within the cavities of the shock isolator from resisting the normal elastomeric response of the shock isolator. In addition by holding the venting till a trigger event occurs one could use the present invention to produce a solid air column support for a cabinet until the trigger event such as a rapid increase in pressure causes a relief valve to open which would then allow the elastomer to act without the solid air column support

FIG. 6 shows a shock isolator comprising a single elastomer shell 40 having a first end 40a and a second end 40b. A base member 51 is secured to end 40a of elastomer shell forming a cavity 40s therein. Similarly, a base member 53 is secured end 40b of elastomer shell 40. A pressure equalizer 52, comprising a pressure relief valve, is located in fluid communication between cavity 42s and an region external to cavity 42s so that when the elastomer shell 40 is compressed a fluid within the cavity 42s can escape from the cavity at sufficiently rapid rate so as to prevent the pressure of the fluid within the cavity 42s from limiting the elastomeric response of the elastomer shell 40. If one desires to have only axially offset support first end 40a and second end 40b can be laterally offset from one another; however, if axial offset support is not desired first end 40a and second end 40b need not be laterally offset. In this condition the elastomer provides compression resistance to shock and vibration. Thus the pressure equalizer provides for controlling the fluid entering the cavity or leaving the cavity to change a dynamic shock or vibration characteristic of the elastomer mount.

In order to illustrate the operation of the shock isolator with and without the pressure equalizer reference should be made to FIG. 7. FIG. 7 shows the force F on a shock isolator plotted along the vertical axis and the compressive displacement of the shock isolator plotted along the horizontal axis.

The first curve 51, which is identified by a solid line, illustrate the response of the shock isolator without a pressure equalizer which results in the fluid pressure in the cavities increasing as the shock isolator compress. Note, even though the force increases the operating range or displacement of the shock isolator is severely limited since the fluid pressure within the shock isolator acts to limit the compression of the shock isolator. This has the effect of shortening the operating range of the shock isolator to a distance denoted by d₁. In other words, the shock isolator “bottoms out” even though the elastomer in the shock isolator could effectively handle greater forces.

The second curve 52, which is identified by a dashed line, illustrate the response of the shock isolator with a pressure equalizer which results in the fluid pressure in the cavities maintained in substantial equilibrium with the fluid pressure outside the shock isolator. Note, as the force increases, the displacement of the shock isolator continues until the elastomer limit is reached. That is, since there is substantial pressure equilibrium between the inside and the outside of the elastomer the fluid pressure within the shock isolator does not limit the compression action of the shock isolator. This has the effect of providing an extended operating range for the elastomer shock isolator. A further feature of the present invention is that it allows one to maintain the inherent elastomeric response of the isolator to be retained whether the elastomer is designed for an elastomer compression mode, an elastomer shear mode or both.

The present invention also provides a method of making a shock isolator to simultaneously provide compression support and shock isolation by molding an elastomer into a shape of a hollow shell such as a tetrahedron 40 having an internal cavity 40s with an apex end 40b and a base end 40a. By molding the elastomer such that the base end 40a and the apex end 40b of the elastomer shell are axially offset from each other one can produce a shock isolator that functions in the shear mode. One can secure base member 51 to the base end 40a of the elastomer shell 40 and base member 53 to the apex end 40b to provide an elastomer shock isolator wherein the resistance to shock and vibration is counterbalanced by shear forces within the elastomer shell.

In order to prevent the elastomer shell 40 from losing its elastomer response characteristics due to increase of fluid pressure in cavity 40s a pressure equalizer 52 is connected to base member 51 to vent fluid into and out of cavity 40s at a rate sufficiently fast so that the pressure of the fluid in the cavity does not substantially interfere with an elastomeric response of the shock isolator.

I claim:

1. A shock isolator for simultaneously isolating shocks and for supporting a static load comprising:
a set of elastomer side walls forming a cavity therein, said side walls having a central axis, a first base end and a second base end, said first base end and said second base end laterally positioned with respect to each other so that a line parallel to said central axis and extending through said first base end does not extend through said second base end and vice versa;
a first base member, said first base member secured to said first base end of said side walls to thereby encapsulate the cavity within the side walls; and
a pressure equalizer, said pressure equalizer venting a fluid from the cavity within the side walls as the shock isolator is compressed and allowing the fluid to enter the cavity within the side walls as the shock isolator returns to an uncompressed state to thereby prevent a fluid pressure differential across the side walls from inhibiting an elastomeric response of the shock isolator

2. The shock isolator of claim 1 wherein the first base end and second base end comprise parallel, spaced-apart surfaces.

3. The shock isolator of claim 2 wherein the pressure equalizer comprises an opening in said first base member, with said opening sufficiently large so as to vent fluid within the cavity at a rate so that the pressure of the fluid in the cavity does not substantially interfere with the elastomeric response of the shock isolator.

4. The shock isolator of claim 1 wherein the elastomer side walls comprise one-piece.

5. The shock isolator of claim 1 wherein said set of elastomer side walls comprises a tetrahedron shaped elastomer with said second base end comprising an apex base end.

6. The shock isolator of claim 5 wherein said shock isolator includes a second tetrahedron shaped elastomer.

7. The shock isolator of claim 1 wherein the pressure equalizer comprises a valve, said valve normally remaining in a closed condition until a pressure in the cavity exceeds a venting pressure whereupon the valve opens to vent the fluid from within the cavity.

8. The shock isolator of claim 1, including a column of pressurized fluid that supports an object until a pressure change in the pressurized fluid triggers the pressure equalizer.

9. The shock isolator of claim 7 wherein the pressure equalizer remains in the open condition to allow the pressure within the cavity and outside the cavity to reach a substantially equalized condition.

10. The shock isolator of claim 5 including a second tetrahedron elastomer with a cavity therein, said second tetrahedron elastomer having a apex base end with said apex base end of said second tetrahedron elastomer secured to said apex base end of said first tetrahedron elastomer to thereby provide serially axial support.

11. The shock isolator of claim 10 wherein the second tetrahedron elastomer is identical to said first tetrahedron elastomer.

12. The shock isolator of claim 11 wherein the first tetrahedron elastomer and the second tetrahedron elastomer comprise one-piece.

13. The shock isolator of claim 12 wherein the first tetrahedron elastomer and the second tetrahedron elastomer each comprise a one-piece hollow elastomer shell

14. The shock isolator of claim 13 including a fluid passage connecting the cavity in the first tetrahedron elastomer and the cavity in the second tetrahedron elastomer.

15. The shock isolator of claim 13 wherein an orifice is located between the cavity in the first tetrahedron elastomer and the cavity in the second tetrahedron elastomer to control the rate of venting between cavities.

16. The shock isolator of claim 14 wherein the cavity in said first tetrahedron elastomer comprise a tetrahedron shaped cavity and the cavity in said second tetrahedron elastomer comprise a tetrahedron shaped cavity.

17. A method of isolating a shock or a vibration while providing compressive static support comprising:
forming an elastomer shell having a cavity and an open end;
securing a base member to the open end to enclose a cavity therein; and
connecting a pressure equalizer to the base member to permit a fluid within the cavity to be expelled therefrom as the shock isolator is compressed and to allow fluid to renter the cavity as the shock isolator returns to an uncompressed state.

18. The method of claim 17 including the step of securing the base member comprises securing a rigid base member to the open end of the elastomer shell.

19. The method of claim 17 wherein the step of connecting a pressure equalizer to the base member comprises forming a vent passage in the base member which is sufficiently large so that fluid in the cavity vents sufficiently fast to prevent the pressure of the fluid from limiting an operating range of the shock isolator.

20. The method of claim 17 including forming the elastomer shell in a tetrahedron shape and securing a second elastomer shell having a tetrahedron shape to the first elastomer shell with each of the elastomer shells having an apex base end in engagement with each other to form a unitary elastomer shell.

21. A shock isolator comprising:
an elastomer shell, said elastomer shell having a first end and a second end;
a base member secured to said elastomer shell, said elastomer shell and said base member forming a cavity therein; and
a pressure equalizer, said pressure equalizer forming a fluid pathway between an interior region of the cavity and an external region of the cavity so that when the elastomer shell is compressed a fluid within the cavity can escape from the cavity at sufficiently rapid rate so as to prevent the fluid within the cavity from limiting the elastomeric response of the elastomer shell to a vibration or a shock force.

22. The shock isolator of claim 19 wherein the first end and the second end are laterally offset other so that a line parallel to a central axis of the elastomer shell which extends through said first end does not extend through said second end and vice versa;

23. The method of claim 15 where the rate of fluid expelled from the cavity is controlled to change a dynamic shock or vibration characteristic

24. The method of claim 15 where the rate of fluid entering the cavity is controlled to change a dynamic shock or vibration characteristic.
